(19) United States
(12) Patent Application Publication
(10) Pub. No.: US 2003/0043404 A1
(43) Pub. Date: Mar. 6, 2003

(54) Control panels for multifunction devices

(76) Inventors: Will Fetherolf, Boise, ID (US); Jeffrey G. Patrick, Eagle, ID (US)

Correspondence Address: HEWLETT-PACKARD COMPANY, Intellectual Property Administration, P.O. Box 272400, Fort Collins, CO, 80527-2400, US

(21) Appl. No.: 09/944,895

(22) Filed: Aug. 31, 2001

(51) Int. Cl. B41J 1/00; G06F 15/00

(52) U.S. Cl. 358/1.15

(57) ABSTRACT

A system of control panels for multifunction devices each have multiple defined regions which are associated with a different function of the multifunction devices. Selectable controls are grouped by functional relation into one or more control groups, where the selectable controls of an individual control group are arranged within a region associated with a particular function. Although a particular control panel may not have selectable controls for a function that is not supported by a multifunction device, the particular control panel still has a defined region for the function.

### TECHNICAL FIELD

This invention relates to control panels for multifunction devices and, in particular, to a system of control panels for similar multifunction devices each having a different set of functions.

### BACKGROUND

Advances in digital technology have created a trend towards reliable and affordable multifunction equipment in place of traditional stand-alone, single purpose devices like photocopiers and fax machines. Multifunction devices, as the name implies, are devices capable of multiple functions such as printing, copying, scanning, and/or faxing.

There are many different communication and media devices, to include single purpose and multifunction devices, available from many different manufacturers. Many of the communication and media devices are designed and appear differently to a user. Typically, the devices have different external housings, control panel layouts, and functional operation differences.

The control panel layouts and operational differences of the many different communication and media devices can be confusing for a user, particularly in an office setting where several single purpose and multifunction devices are available to facilitate the user's business. Typically, some of the office devices will be older, and some will be newer and more advanced from a technological and operational standpoint. While a user may be able to easily ascertain the operation of an older or single purpose device, a newer and advanced multifunction device can have multi-functional controls that initiate different functions, and can be more difficult and intimidating to use.

From a user standpoint, it is desirable to be able to approach a multifunction device and intuitively know from the control panel layout both the function capabilities of the device and what functions and/or operations the various selectable controls on the control panel are designed to initiate. Furthermore, in the office setting example, it is desirable to be able to quickly determine the functions of any number of multifunction devices by a quick review of the devices' control panels, particularly for multifunction devices that look similar and which are produced by the same manufacturer.

### SUMMARY

A system of control panels for multifunction devices each having multiple defined regions which are associated with a different function of the multifunction devices. The control panel regions correspond to a fax region, print region, copy region, and scan region. The control panels also have a display panel to display information pertaining to a multifunction device.

Individual selectable controls are grouped by functional relation into one or more control groups, where the selectable controls of an individual control group are arranged within a functional region on a control panel associated with a particular function. Although a particular control panel may not have selectable controls for a function that is not supported by a multifunction device, the particular control panel still has a defined region for the function.

### BRIEF DESCRIPTION OF THE DRAWINGS

The same numbers are used throughout the drawings to reference like features and components.

FIG. 1 is block diagram that illustrates various components of an exemplary multifunction device.

FIG. 2 illustrates a control panel for a multifunction fax-printer-copier-scanner device.

FIG. 3 illustrates a control panel for a multifunction printer-copier-scanner device.

FIG. 4 illustrates a control panel for a multifunction printer-copier device.

FIG. 5 is a flow diagram that describes a method for producing control panels for multifunction devices.

### DETAILED DESCRIPTION

Introduction

The following describes a system of control panels for multifunction devices. Each of the control panels have similarly defined regions of selectable controls for device operation. Although each of the multifunction devices have a different set of functions, such as faxing, printing, copying, and/or scanning, the control panels for each have the same functional layout and intuitive arrangement and groupings of selectable controls.

The similar control panels for the different multifunction devices identify the multifunction devices as having some similar functionality, and the similar control panels' controls and functional operation are the same and intuitive from one control panel to the next. The similar control panels for a product line of multifunction devices having different functions lend to product recognition and user familiarity, as well as to reducing production costs.

Exemplary Multifunction Device Architecture

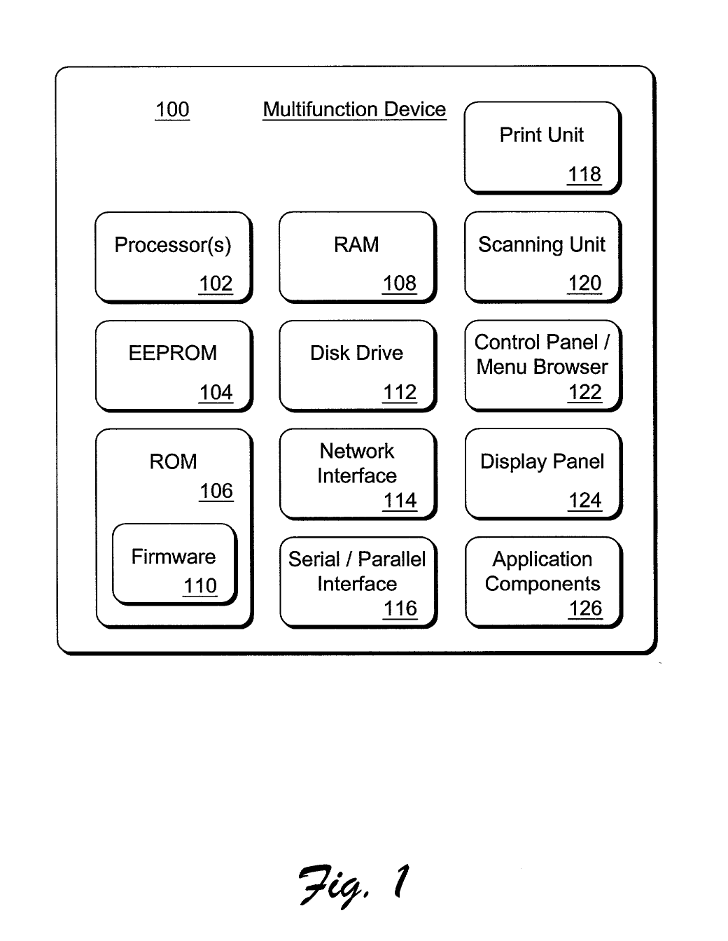

FIG. 1 illustrates various components of an exemplary multifunction device 100. A multifunction device, as the name implies, is a device capable of multiple functions which are related, but not limited to, printing, copying, scanning, to include image acquisition and text recognition, sending and receiving faxes, print media handling, and/or data communication, either by print media or e-media, such as via email or electronic fax.

Multifunction device 100 includes one or more processors 102, an electrically erasable programmable read-only memory (EEPROM) 104, ROM 106 (non-erasable), and a random access memory (RAM) 108. Although multifunction device 100 is illustrated having an EEPROM 104 and ROM 106, a particular device may only include one of the memory components. Additionally, although not shown, a system bus typically connects the various components within multifunction device 100.

Multifunction device 100 also includes a firmware component 110 that is implemented as a permanent memory module stored on ROM 106. Firmware 110 is programmed and tested like software, and is distributed with the multifunction device 100. Firmware 110 can be implemented to coordinate operations of the hardware within multifunction device 100 and contains programming constructs used to perform such operations.

Processor(s) 102 process various instructions to control the operation of multifunction device 100 and to communicate with other electronic and computing devices. The memory components, EEPROM 104, ROM 106, and RAM 108, store various information and/or data such as configuration information, fonts, templates, print data, scanned image data, and menu structure information. Although not shown, a particular multifunction device can also include a flash memory device in place of or in addition to EEPROM 104 and ROM 106.

Multifunction device 100 also includes a disk drive 112, a network interface 114, and a serial and/or parallel interface 116. Disk drive 112 provides additional storage for data being printed, copied, scanned, and/or faxed, or other information maintained by multifunction device 100. Although multifunction device 100 is illustrated having both RAM 108 and a disk drive 112, a particular multifunction device may include either RAM 108 or disk drive 112, depending on the storage needs of the multifunction device.

Network interface 114 provides a connection between multifunction device 100 and a data communication network. Network interface 114 allows devices coupled to a common data communication network to send print jobs, faxes, menu data, and other information to multifunction device 100 via the network. Similarly, the serial and/or parallel interface 116 provides a data communication path directly between multifunction device 100 and another electronic or computing device. Although multifunction device 100 is illustrated having a network interface 114 and serial and/or parallel interface 116, a particular multifunction device may only include one such interface component.

Multifunction device 100 also has a print unit 118 that includes mechanisms arranged to selectively apply ink (e.g., liquid ink, toner, etc.) to a print media such as paper, plastic, fabric, and the like in accordance with print data corresponding to a print job. For example, print unit 118 can include a conventional laser printing mechanism that selectively causes toner to be applied to an intermediate surface of a drum or belt. The intermediate surface can then be brought within close proximity of a print media in a manner that causes the toner to be transferred to the print media in a controlled fashion. The toner on the print media can then be more permanently fixed to the print media, for example, by selectively applying thermal energy to the toner.

Print unit 118 can also be configured to support duplex printing, for example, by selectively flipping or turning the print media as required to print on both sides. Those skilled in the art will recognize that there are many different types of print units available, and that for the purposes of the present invention, print unit 118 can include any of these different types.

Multifunction device 100 also has a scanning unit 120 that can be implemented as an optical scanner to produce machine-readable image data signals that are representative of a scanned image, such as a photograph or a page of printed text. The image data signals produced by scanning unit 120 can be used to reproduce the scanned image on a display device, such as a computer display or a printer.

Multifunction device 100 also includes a control panel and menu browser 122, and a display panel 124. The control panel and menu browser 122 allows a user of the multifunction device 100 to navigate the device's menu structure. Control panel 122 can be indicators or a series of buttons, switches, or other selectable controls that are manipulated by a user of the multifunction device. Display panel 124 is a graphical display that provides information regarding the status of the multifunction device 100 and the current options available to a user through the menu structure.

Multifunction device 100 can, and typically does include application components 126 that provide a runtime environment in which software applications or components can run or execute. Those skilled in the art will recognize that there are many different types of available runtime environments. A runtime environment facilitates the extensibility of multifunction device 100 by allowing various interfaces to be defined that, in turn, allow the application components 126 to interact with the multifunction device.

General reference is made herein to multifunction devices and digital multifunction devices, such as multifunction device 100. Although specific examples may refer to one or more multifunction devices having particular functionalities, such examples are not meant to limit the scope of the claims or the description, but are meant to provide a specific understanding of the described implementations.

Exemplary Multifunction Device Control Panels

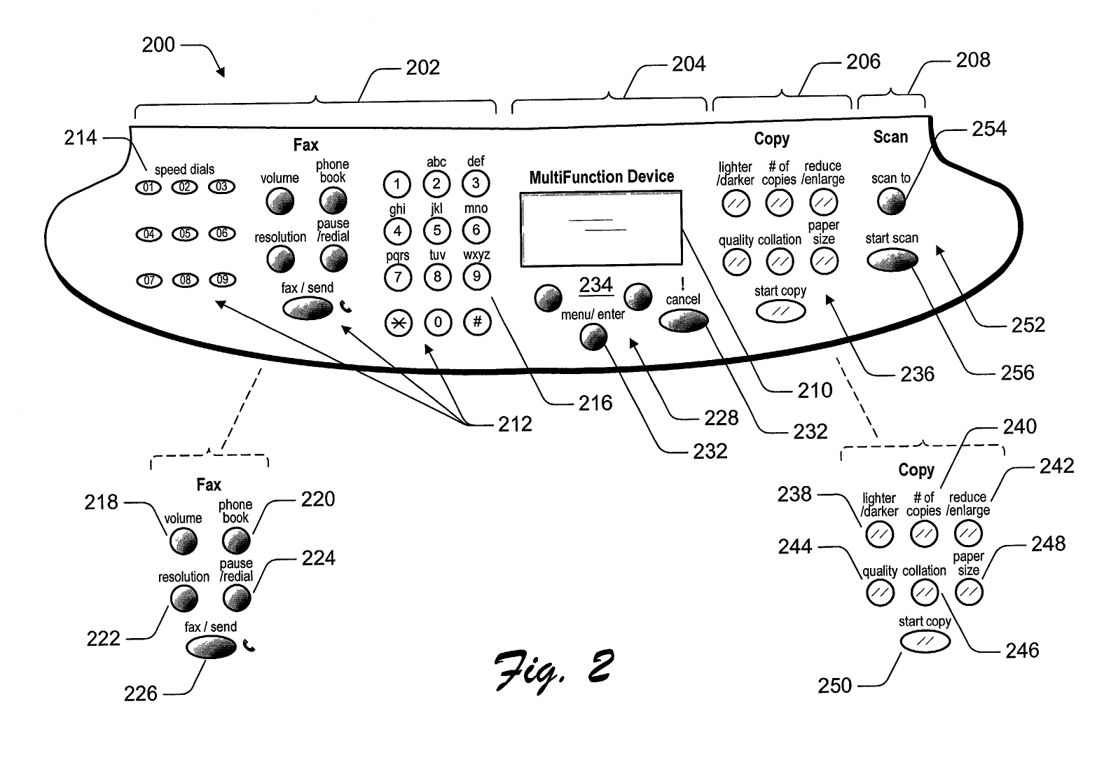

FIGS. 2, 3, and 4 illustrate various exemplary control panel configurations for digital multifunction devices having different sets of fax, print, copy, and scan functions. Each control panel is a recognizable device operation interface for a multifunction device. Although each multifunction device may be capable of a different set of functions, the control panel for each identifies the set of functions for a particular multifunction device by having the same applicable function controls located in the same region of one control panel to the next.

FIG. 2 illustrates a control panel 200 for a digital multifunction fax-printer-copier-scanner device. The control panel 200 includes controls and indicators to facilitate utilizing the components and features of the exemplary multifunction device 100 (FIG. 1).

Control panel 200 includes a fax region 202, a print region 204, a copy region 206, and a scan region 208, as well as a display panel 210. The multiple regions of control panel 200 are each associated with a different function of a multifunction fax-printer-copier-scanner device. Display panel 210 displays information pertaining to the operation and use of the multifunction device.

Fax region 202 includes a fax control group 212 of selectable faxing controls associated with the fax function of the multifunction device. The selectable faxing controls include speed dial selectable controls 214 to dial a destination fax number stored in memory, and a keypad 216 having numeric touch controls to dial a destination fax number. The selectable faxing controls also include a volume control 218 to adjust the volume of indication tones, and the like, a phone book control 220 to list destination fax numbers on the display panel 210, a fax resolution control 222, a pause/redial control 224 to redial a destination fax number, or pause the transmission a fax, and a fax/send control 226 to initiate a fax.

Print region 204 includes a print control group 228 of selectable printing controls associated with the print function of the multifunction device. The selectable printing controls include a cancel control 230 to cancel a print job, a menu/enter control 232 to select menu options and interface with information displayed on the display panel 210, and selectable controls 234 to further interface with information displayed on the display panel 210.

Copy region 206 includes a copy control group 236 of selectable copying controls associated with the copy function of the multifunction device. The selectable copying controls include a lighter/darker control 238 to select the amount of copy exposure, a control 240 to select a number of copies, a reduce/enlarge control 242 to select copy size, a copy quality control 244, a collation control 246 to select collation of copies, a paper size selection control 248, and start copy control 250 to initiate making a copy.

Scan region 208 includes a scan control group 252 of selectable scanning controls associated with the scan function of the multifunction device. The selectable scanning controls selected include a scan to selection control 254 to select a destination location, such as a file or memory location, for a scanned image, and a start scan control 256 to initiate a scanning an image.

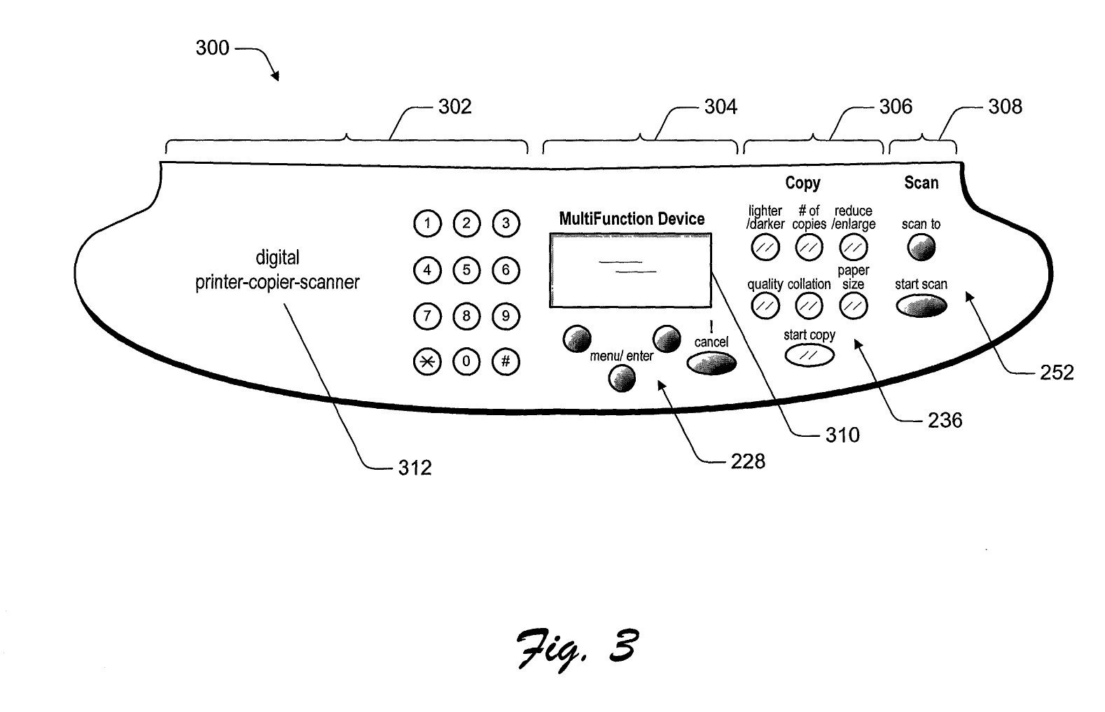

FIG. 3 illustrates a control panel 300 for a digital multifunction printer-copier-scanner device. The control panel 300 includes controls and indicators to facilitate utilizing the components and features of the exemplary multifunction device 100 (FIG. 1). Control panel 300 has the same control groups of selectable controls positioned in the same regions on the control panel as that of control panel 200 (FIG. 2), except that control panel 300 is for a multifunction device that does not have a fax function. Although control panel 300 does not have a fax control group of selectable faxing controls, the control panel 300 still has a dedicated fax region 302.

Additionally, control panel 300 includes a print region 304, a copy region 306, and a scan region 308, as well as a display panel 310. The multiple regions (e.g., print, copy, and scan regions) of control panel 300 are each associated with a different function of a multifunction printer-copier-scanner device. Display panel 310 displays information pertaining to the operation and use of the multifunction device.

Print region 304 includes the same print control group 228 of selectable printing controls associated with the print function of the multifunction device as that of control panel 200 (FIG. 2). The selectable printing controls are described with reference to control panel 200 and print control group 228.

Copy region 306 includes the same copy control group 236 of selectable copying controls associated with the copy function of the multifunction device as that of control panel 200 (FIG. 2). The selectable copying controls are described with reference to control panel 200 and copy control group 236.

Scan region 308 includes the same scan control group 252 of selectable scanning controls associated with the scan function of the multifunction device as that of control panel 200 (FIG. 2). The selectable scanning controls are described with reference to control panel 200 and copy control group 236.

Control panel 300 also includes a label 312 to indicate the different functions of the multifunction printer-copier-scanner device, and to identify a position on the control panel 300 of the control groups corresponding to the different functions. For example, the “printer-copier-scanner” label 312 indicates the three primary functions of the multifunction printer-copier-scanner device. The “printer-copier-scanner” label 312 also identifies that the print control group 228 (region 304) is positioned on the control panel 300 to the left and adjacent the copy control group 236 (region 306). The position of the copy control group 236 is followed by the scan control group 252 (region 308), just as the label 312 indicates.

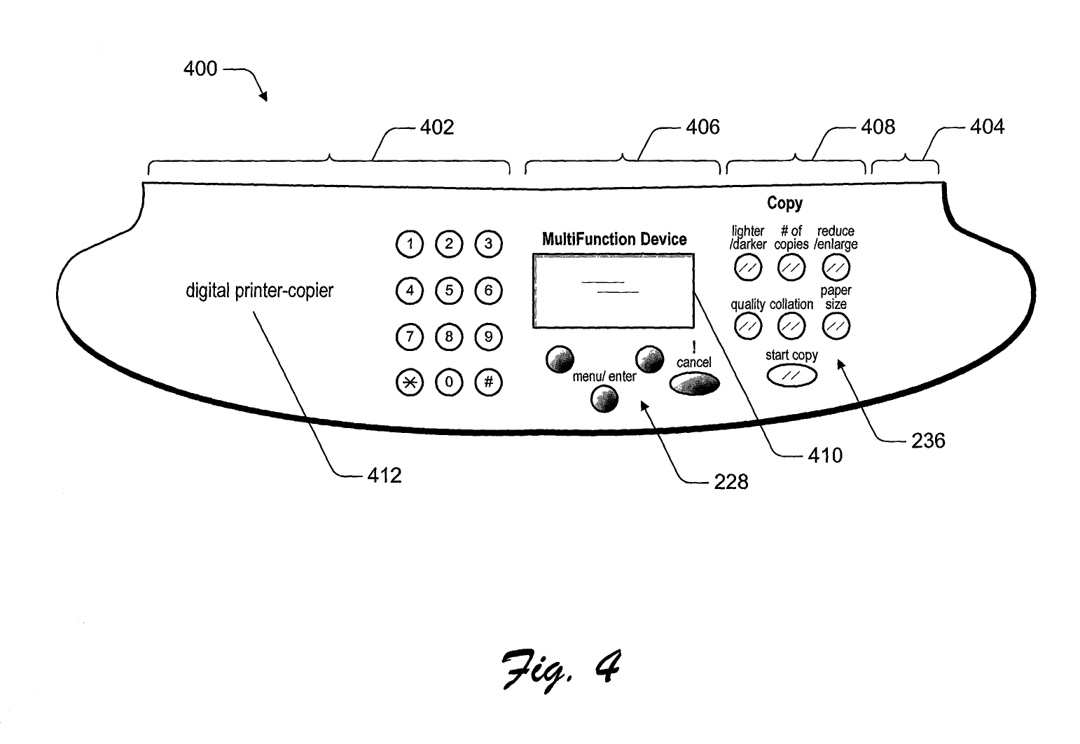

FIG. 4 illustrates a control panel 400 for a digital multifunction printer-copier device. The control panel 400 includes controls and indicators to facilitate utilizing the components and features of the exemplary multifunction device 100 (FIG. 1). Control panel 400 has the same control groups of selectable controls positioned in the same regions on the control panel as that of control panel 200 (FIG. 2) and control panel 300 (FIG. 3), except that control panel 400 is for a multifunction device that does not have a fax function or a scan function. Although control panel 400 does not have a fax control group of selectable faxing controls, or a scan control group of selectable scanning controls, the control panel 400 still has a dedicated fax region 402, and a dedicated scan region 404.

Additionally, control panel 400 includes a print region 406 and a copy region 408, as well as a display panel 410. The multiple regions (e.g., print and copy regions) of control panel 400 are each associated with a different function of a multifunction printer-copier device. Display panel 410 displays information pertaining to the operation and use of the multifunction device.

Print region 406 includes the same print control group 228 of selectable printing controls associated with the print function of the multifunction device as that of control panel 200 (FIG. 2) and control panel 300 (FIG. 3). The selectable printing controls are described with reference to control panel 200 and print control group 228.

Copy region 408 includes the same copy control group 236 of selectable copying controls associated with the copy function of the multifunction device as that of control panel 200 (FIG. 2) and control panel 300 (FIG. 3). The selectable copying controls are described with reference to control panel 200 and copy control group 236.

Control panel 400 also includes a label 412 to indicate the different functions of the multifunction printer-copier device, and to identify a position on the control panel 400 of the control groups corresponding to the different functions. For example, the “printer-copier” label 412 indicates the two primary functions of the multifunction printer-copier device. The “printer-copier” label 412 also identifies that the print control group 228 (region 406) is positioned on the control panel 400 to the left and adjacent the copy control group 236 (region 408).

Although the control panels 200 (FIG. 2), 300 (FIG. 3), and 400 (FIG. 4) each have different selectable controls corresponding to different multifunction devices, the control panels each have the same defined functional regions, layout, and intuitive arrangement of the selectable controls.

Methods for Producing Control Panels for Multifunction Devices

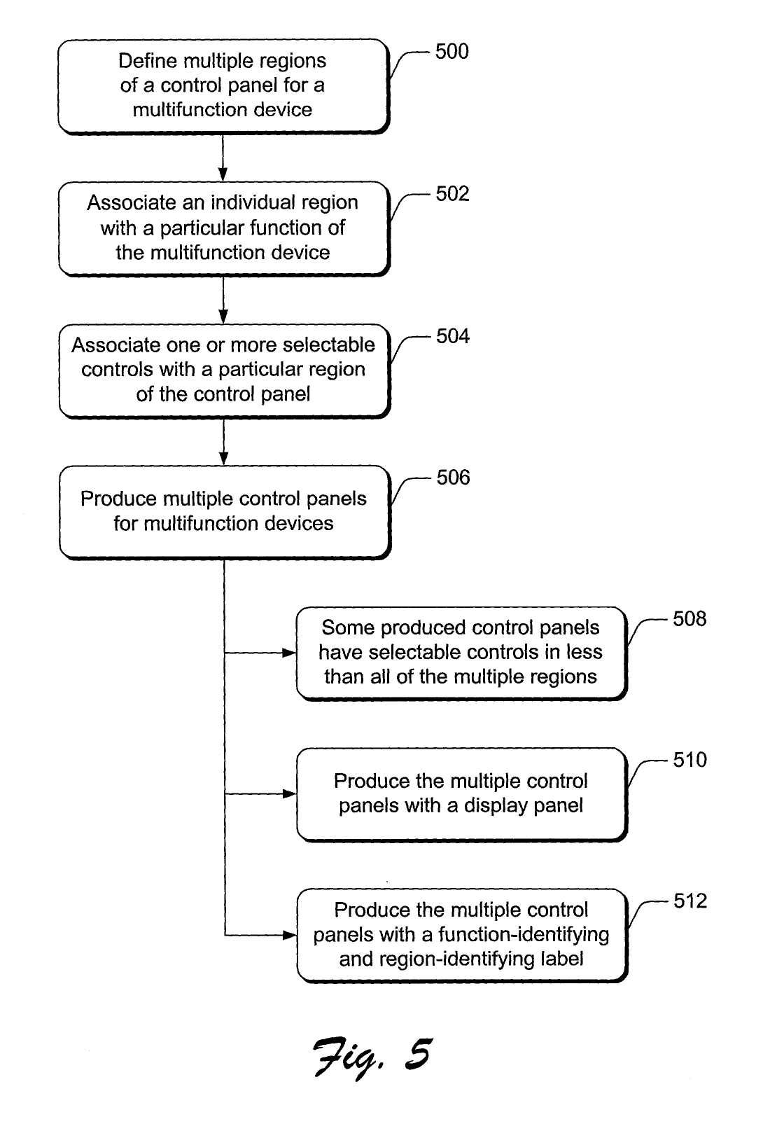

FIG. 5 illustrates a method for producing control panels for multifunction devices. The order in which the method is described is not intended to be construed as a limitation.

At block 500, multiple regions of a control panel for a multifunction device are defined. For example, control panel 200 (FIG. 2) has a defined fax region 202, a defined print region 204, a defined copy region 206, and a defined scan region 208.

At block 502, an individual region of the control panel is associated with a particular function of the multifunction device, where the particular function is selected from a group of functions including printing, copying, scanning, and faxing.

At block 504, one or more selectable controls are associated with a particular region of the control panel. The selectable controls that are associated with a particular region each have an individual functionality associated with the function of the particular region. For example, the selectable faxing controls of fax control group 212 are associated with fax region 202, the selectable printing controls of print control group 228 are associated with print region 204, the selectable copying controls of copy control group 236 are associated with copy region 206, and the selectable scanning controls of scan control group 252 are associated with print region 208.

At block 506, multiple control panels for multifunction devices are produced, some of which have selectable controls in less than all of the multiple regions (block 508). For example, control panel 300 (FIG. 3) has a defined fax region 302, a defined print region 304, a defined copy region 306, and a defined scan region 308. However, fax region 302 of control panel 300 is without selectable faxing controls because the multifunction device does not have a fax function.

Additionally, producing the multiple control panels (block 506) includes producing the control panels with a display panel for displaying information pertaining to the multifunction device (block 510). Producing the multiple control panels also includes producing the control panels with a label to indicate the different functions of the multifunction device, and to identify a position on the control panel of the selectable controls corresponding to a particular region and/or function of a particular region (block 512).

Conclusion

A system of control panels for multifunction devices having some different functions identify the multifunction devices as having some similar functionality, and the similar control panels' controls and functional operation are the same and intuitive from one control panel to the next. The similar control panels for a product line of multifunction devices lend to product recognition and user familiarity, as well as to reducing production costs.

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. A system of control panels for multifunction print devices, the system of control panels comprising multiple control panels each of which include:
multiple regions each of which are associated with a different function of the multifunction print devices;
selectable controls grouped by functional relation into one or more control groups, the selectable controls of an individual control group arranged within a region associated with a function of the individual control group; and
at least one control panel having the selectable controls arranged within less than all of the multiple regions.

2. A system of control panels as recited in claim 1, wherein the multiple control panels each include a display panel configured to display information pertaining to a multifunction print device.

3. A system of control panels as recited in claim 1, wherein at least one control panel further includes a label to indicate the different functions of a particular multifunction print device, and to identify a position on the control panel of the control groups corresponding to the different functions.

4. A system of control panels as recited in claim 1, wherein the multiple regions include:
a print region having a print control group of selectable printing controls associated with a print function of a multifunction print devices; and
a copy region having a copy control group of selectable copying controls associated with a copy function of the multifunction print devices.

5. A system of control panels as recited in claim 1, wherein the multiple regions include:
a print region having a print control group of selectable printing controls associated with a print function of a multifunction print device;
a copy region having a copy control group of selectable copying controls associated with a copy function of the multifunction print device;
a scan region without selectable scanning controls; and
a fax region without selectable faxing controls.

6. A system of control panels as recited in claim 1, wherein the multiple control panels each include a display panel configured to display information pertaining to a multifunction print device, and wherein the multiple regions include:
a print region having a print control group of selectable printing controls associated with a print function of the multifunction print device; and
a copy region having a copy control group of selectable copying controls associated with a copy function of the multifunction print device.

7. A system of control panels as recited in claim 1, wherein the multiple regions include:
a print region having a print control group of selectable printing controls associated with a print function of the multifunction print devices, the selectable printing controls selected from a group including:
a first printing control configured to cancel a print job;
a second printing control configured to select a menu option on a display panel;
one or more display controls configured to display information on the display panel;
a copy region having a copy control group of selectable copying controls associated with a copy function of the multifunction print devices, the selectable copying controls selected from a group including:
a first copying control configured to select copy exposure;
a second copying control configured to select a number of copies;
a third copying control configured to select copy size;
a fourth copying control configured to select copy quality;
a fifth copying control configured to select collation of copies;
a sixth copying control configured to select paper size; and
a seventh copying control configured to initiate a copy.

8. A system of control panels as recited in claim 1, wherein the multiple regions include:
a print region having a print control group of selectable printing controls associated with a print function of a multifunction print device;
a copy region having a copy control group of selectable copying controls associated with a copy function of the multifunction print device; and
a scan region having a scan control group of scanning controls associated with a scan function of the multifunction print device.

9. A system of control panels as recited in claim 1, wherein the multiple regions include:
a print region having a print control group of selectable printing controls associated with a print function of a multifunction print device;
a copy region having a copy control group of selectable copying controls associated with a copy function of the multifunction print device;
a scan region having a scan control group of scanning controls associated with a scan function of the multifunction print device; and
a fax region without selectable faxing controls.

10. A system of control panels as recited in claim 1, wherein the multiple control panels each include a display panel configured to display information pertaining to a multifunction print device, and wherein the multiple regions include:
a print region having a print control group of selectable printing controls associated with a print function of the multifunction print device;
a copy region having a copy control group of selectable copying controls associated with a copy function of the multifunction print device; and
a scan region having a scan control group of selectable scanning controls associated with a scan function of the multifunction print device.

11. A system of control panels as recited in claim 7, wherein the multiple regions further include:
a scan region having a scan control group of selectable scanning controls associated with a scan function of the multifunction print device, the selectable scanning controls selected from a group including:
a first scanning control configured to select a destination location for a scanned image; and
a second scanning control configured to initiate a scan.

12. A system of control panels as recited in claim 1, wherein the multiple regions include:
a print region having a print control group of selectable printing controls associated with a print function of a multifunction print device;
a copy region having a copy control group of selectable copying controls associated with a copy function of the multifunction print device;
a scan region having a scan control group of selectable scanning controls associated with a scan function of the multifunction print device; and
a fax region having a fax control group of selectable faxing controls associated with a fax function of the multifunction device.

13. A system of control panels as recited in claim 1, wherein the multiple control panels each include a display panel configured to display information pertaining to a multifunction print device, and wherein the multiple regions include:
a print region having a print control group of selectable printing controls associated with a print function of the multifunction print device;
a copy region having a copy control group of selectable copying controls associated with a copy function of the multifunction print device;
a scan region having a scan control group of selectable scanning controls associated with a scan function of the multifunction print device; and
a fax region having a fax control group of selectable faxing controls associated with a fax function of the multifunction device.

14. A system of control panels as recited in claim 11, wherein the multiple regions include:
a fax region having a fax control group of selectable faxing controls associated with a fax function of the multifunction device, the selectable faxing controls selected from a group including:
a first faxing control configured to adjust a volume of an audible output;
a second faxing control configured to list destination fax numbers;
a third faxing control configured to select fax resolution;
a fourth faxing control configured to redial a destination fax number, and further configured to pause transmitting a fax;
a fifth faxing control configured to initiate a fax;
a keypad to dial a destination fax number; and
one or more speed dial selectable controls to dial a destination fax number.

15. A control panel for multifunction print devices, comprising:
multiple regions each of which are associated with a different function of the multifunction print devices;
selectable controls grouped by functional relation into one or more control groups, the selectable controls of an individual control group arranged within a region associated with a function of the individual control group; and
the selectable controls arranged within less than all of the multiple regions.

16. A control panel as recited in claim 15, further comprising a display panel configured to display information pertaining to a multifunction print device.

17. A control panel as recited in claim 15, further comprising a label to indicate the different functions of a particular multifunction print device, and to identify a position on the control panel of the control groups corresponding to the different functions.

18. A control panel as recited in claim 15, wherein the multiple regions include:
a print region having a print control group of selectable printing controls associated with a print function of a multifunction print device;
a copy region having a copy control group of selectable copying controls associated with a copy function of the multifunction print device;
a scan region without selectable scanning controls; and
a fax region without selectable faxing controls.

19. A control panel as recited in claim 15, wherein the multiple regions include:
a print region having a print control group of selectable printing controls associated with a print function of the multifunction print devices, the selectable printing controls selected from a group including:
a first printing control configured to cancel a print job;
a second printing control configured to select a menu option on a display panel;
one or more display controls configured to display information on the display panel;
a copy region having a copy control group of selectable copying controls associated with a copy function of the multifunction print devices, the selectable copying controls selected from a group including:
a first copying control configured to select copy exposure;
a second copying control configured to select a number of copies;
a third copying control configured to select copy size;
a fourth copying control configured to select copy quality;
a fifth copying control configured to select collation of copies;
a sixth copying control configured to select paper size; and
a seventh copying control configured to initiate a copy.

20. A control panel as recited in claim 15, wherein the multiple regions include:
a print region having a print control group of selectable printing controls associated with a print function of a multifunction print device;
a copy region having a copy control group of selectable copying controls associated with a copy function of the multifunction print device;
a scan region having a scan control group of scanning controls associated with a scan function of the multifunction print device; and
a fax region without selectable faxing controls.

21. A control panel as recited in claim 19, wherein the multiple regions further include:
a scan region having a scan control group of selectable scanning controls associated with a scan function of the multifunction print device, the selectable scanning controls selected from a group including:
a first scanning control configured to select a destination location for a scanned image; and
a second scanning control configured to initiate a scan.

22. A control panel as recited in claim 15, wherein the multiple regions include:
a print region having a print control group of selectable printing controls associated with a print function of a multifunction print device;
a copy region having a copy control group of selectable copying controls associated with a copy function of the multifunction print device;
a scan region having a scan control group of selectable scanning controls associated with a scan function of the multifunction print device; and
a fax region having a fax control group of selectable faxing controls associated with a fax function of the multifunction device.

23. A control panel as recited in claim 15, wherein the multiple control panels each include a display panel configured to display information pertaining to a multifunction print device, and wherein the multiple regions include:
a print region having a print control group of selectable printing controls associated with a print function of the multifunction print device;
a copy region having a copy control group of selectable copying controls associated with a copy function of the multifunction print device;
a scan region having a scan control group of selectable scanning controls associated with a scan function of the multifunction print device; and
a fax region having a fax control group of selectable faxing controls associated with a fax function of the multifunction device.

24. A control panel as recited in claim 21, wherein the multiple regions further include:
a fax region having a fax control group of selectable faxing controls associated with a fax function of the multifunction device, the selectable faxing controls selected from a group including:
a first faxing control configured to adjust a volume of an audible output;
a second faxing control configured to list destination fax numbers;
a third faxing control configured to select fax resolution;
a fourth faxing control configured to redial a destination fax number, and further configured to pause transmitting a fax;
a fifth faxing control configured to initiate a fax;
a keypad to dial a destination fax number; and
one or more speed dial selectable controls to dial a destination fax number.

25. A system of control panels for multifunction devices, the system of control panels comprising multiple control panels each of which include:
multiple regions each of which are associated with a different function of the multifunction devices;
one or more selectable controls arranged within one or more of the multiple regions, the one or more selectable controls within any one region having individual functionality associated with the different function of the one region;
the multiple regions including a print region having one or more selectable printing controls associated with a print function of the multifunction devices, and a copy region having one or more selectable copying controls associated with a copy function of the multifunction devices; and
at least one control panel having selectable controls arranged within less than all of the multiple regions.

26. A system of control panels as recited in claim 25, wherein the multiple control panels each include a display panel configured to display information pertaining to a multifunction device.

27. A system of control panels as recited in claim 25, wherein at least one control panel includes a label to indicate the different functions of a particular multifunction device, and to identify a position on the control panel of the one or more selectable controls corresponding to a particular different function.

28. A system of control panels as recited in claim 25, wherein the multiple regions further include a scan region without selectable scanning controls, and a fax region without selectable faxing controls.

29. A system of control panels as recited in claim 25, wherein:
the one or more selectable printing controls are selected from a group including:
a first printing control configured to cancel a print job;
a second printing control configured to select a menu option on a display panel;
one or more display controls configured to display information on the display panel;
the one or more selectable copying controls are selected from a group including:
a first copying control configured to select copy exposure;
a second copying control configured to select a number of copies;
a third copying control configured to select copy size;
a fourth copying control configured to select copy quality;
a fifth copying control configured to select collation of copies;
a sixth copying control configured to select paper size; and
a seventh copying control configured to initiate a copy.

30. A system of control panels as recited in claim 25, wherein the multiple regions further include a scan region having one or more selectable scanning controls associated with a scan function of the multifunction device.

31. A system of control panels as recited in claim 25, wherein the multiple control panels each include a display panel configured to display information pertaining to a multifunction device, and wherein the multiple regions further include a scan region having one or more selectable scanning controls associated with a scan function of the multifunction device.

32. A system of control panels as recited in claim 29, wherein the multiple regions further include a scan region having one or more selectable scanning controls associated with a scan function of the multifunction device, the one or more selectable scanning controls selected from a group including:
a first scanning control configured to select a destination location for a scanned image; and
a second scanning control configured to initiate a scan.

33. A system of control panels as recited in claim 25, wherein the multiple regions further include:
a scan region having one or more selectable scanning controls associated with a scan function of the multifunction device; and
a fax region having one or more selectable faxing controls associated with a fax function of the multifunction device.

34. A system of control panels as recited in claim 25, wherein the multiple control panels each include a display panel configured to display information pertaining to a multifunction device, and wherein the multiple regions further include:
a scan region having one or more selectable scanning controls associated with a scan function of the multifunction device; and
a fax region having one or more selectable faxing controls associated with a fax function of the multifunction device.

35. A system of control panels as recited in claim 32, wherein:
the multiple regions further include a fax region having one or more selectable faxing controls associated with a fax function of the multifunction device, the one or more selectable faxing controls selected from a group including:
a first faxing control configured to adjust a volume of an audible output;
a second faxing control configured to list destination fax numbers;
a third faxing control configured to select fax resolution;
a fourth faxing control configured to redial a destination fax number, and further configured to pause transmitting a fax;
a fifth faxing control configured to initiate a fax;
a keypad to dial a destination fax number; and
one or more speed dial selectable controls to dial a destination fax number.

36. A method, comprising:
defining multiple regions of a control panel for a multifunction device;
associating an individual region with a particular function of the multifunction device, the particular function selected from a group of functions including printing, copying, scanning, and faxing;
associating one or more selectable controls with the individual region, the one or more selectable controls having individual functionality associated with the particular function of the individual region; and
producing multiple control panels some of which have selectable controls in less than all of the multiple regions.

37. A method as recited in claim 36, wherein producing includes producing the control panel with a display panel for displaying information pertaining to the multifunction device.

38. A method as recited in claim 36, wherein producing includes producing the control panel with a label to indicate the different functions of the multifunction device, and to identify a position on the control panel of the one or more selectable controls corresponding to a particular region.

39. A method as recited in claim 36, wherein associating the one or more selectable controls includes:
associating one or more selectable printing controls with an individual region corresponding to a printing function of the multifunction device; and
associating one or more selectable copying controls with an individual region corresponding to a copying function of the multifunction device.

40. A method as recited in claim 36, wherein producing includes producing the control panel with a display panel for displaying information pertaining to the multifunction device, and wherein associating the one or more selectable controls includes:
associating one or more selectable printing controls with an individual region corresponding to a printing function of the multifunction device; and
associating one or more selectable copying controls with an individual region corresponding to a copying function of the multifunction device.

41. A method as recited in claim 36, wherein associating the one or more selectable controls includes:
associating one or more selectable printing controls with an individual region corresponding to a printing function of the multifunction device, the one or more selectable printing controls being selected from a group including:
a first printing control for canceling a print job;
a second printing control for selecting a menu option on a display panel;
one or more display controls for displaying information on the display panel;
associating one or more selectable copying controls with an individual region corresponding to a copying function of the multifunction device, the one or more selectable copying controls being selected from a group including:
a first copying control for selecting copy exposure;
a second copying control for selecting a number of copies;
a third copying control for selecting copy size;
a fourth copying control for selecting copy quality;
a fifth copying control for selecting collation of copies;
a sixth copying control for selecting paper size; and
a seventh copying control for initiating a copy.

42. A method as recited in claim 36, wherein associating the one or more selectable controls includes:
associating one or more selectable printing controls with an individual region corresponding to a printing function of the multifunction device;
associating one or more selectable copying controls with an individual region corresponding to a copying function of the multifunction device; and
associating one or more selectable scanning controls with an individual region corresponding to a scanning function of the multifunction device.

43. A method as recited in claim 36, wherein producing includes producing the control panel with a display panel for displaying information pertaining to the multifunction device, and wherein associating the one or more selectable controls includes:
associating one or more selectable printing controls with an individual region corresponding to a printing function of the multifunction device;
associating one or more selectable copying controls with an individual region corresponding to a copying function of the multifunction device; and
associating one or more selectable scanning controls with an individual region corresponding to a scanning function of the multifunction device.

44. A method as recited in claim 41, wherein associating the one or more selectable controls includes associating one or more selectable scanning controls with an individual region corresponding to a scanning function of the multifunction device, the one or more selectable scanning controls being selected from a group including:
a first scanning control for selecting a destination location for a scanned image; and
a second scanning control for initiating a scan.

45. A method as recited in claim 36, wherein associating the one or more selectable controls includes:
associating one or more selectable printing controls with an individual region corresponding to a printing function of the multifunction device;
associating one or more selectable copying controls with an individual region corresponding to a copying function of the multifunction device;
associating one or more selectable scanning controls with an individual region corresponding to a scanning function of the multifunction device; and
associating one or more selectable faxing controls with an individual region corresponding to a faxing function of the multifunction device.

46. A method as recited in claim 36, wherein producing includes producing the control panel with a display panel for displaying information pertaining to the multifunction device, and wherein associating the one or more selectable controls includes:
associating one or more selectable printing controls with an individual region corresponding to a printing function of the multifunction device;
associating one or more selectable copying controls with an individual region corresponding to a copying function of the multifunction device;
associating one or more selectable scanning controls with an individual region corresponding to a scanning function of the multifunction device; and
associating one or more selectable faxing controls with an individual region corresponding to a faxing function of the multifunction device.

47. A method as recited in claim 44, wherein associating the one or more selectable controls includes associating one or more selectable faxing controls with an individual region corresponding to a faxing function of the multifunction device, the one or more selectable faxing controls being selected from a group including:
a first faxing control for adjusting a volume of an audible output;
a second faxing control for listing destination fax numbers;
a third faxing control for selecting fax resolution;
a fourth faxing control for redialing a destination fax number, and for pausing transmitting a fax;
a fifth faxing control for initiating a fax;
a keypad for dialing a destination fax number; and
one or more speed dial selectable controls for dialing a destination fax number.
